(19) United States
(12) Patent Application Publication
(10) Pub. No.: US 2026/0254335 A1
(43) Pub. Date: Aug. 27, 2026

(54) MULTIMODAL ACTUATOR SYSTEM AND METHOD

(71) Applicant: The Research Foundation for The State University of New York, Albany, NY (US)

(72) Inventors: Si Chen, Albany, NY (US); Shanshan Yao, Albany, NY (US)

(73) Assignee: The Research Foundation for The State University of New York, Albany, NY (US)

(21) Appl. No.: 19/540,105

(22) Filed: Feb. 13, 2026

Related U.S. Application Data
(60) Provisional application No. 63/761,628, filed on Feb. 21, 2025.

(51) Int. Cl. H02K 35/02; G06F 3/01

(52) U.S. Cl. CPC H02K 35/02; G06F 3/014; G06F 3/016

(57) ABSTRACT

Certain aspects of the disclosure provide a multimodal actuator. The multimodal actuator includes a plurality of electromagnetic coils having a planar spiral aspect. The plurality of electromagnetic coils may be arranged in a partially overlapping pattern. Additionally, the multimodal actuator includes a magnet in magnetic communication with the plurality of electromagnetic coils. Also, the multimodal actuator includes a spring structure, having a first surface facing the magnet, and a second surface opposite the first surface. Micro-pillars may be optionally arranged on a surface of the spring structure opposite the magnet. The micro-pillars may be configured to communicate movement of the magnet to a contact region of skin.

### CROSS-REFERENCE TO RELATED APPLICATIONS

This application claims the benefit of and priority to U.S. Provisional Patent Application No. 63/761,628, filed on Feb. 21, 2025, the entire contents of which are hereby incorporated by reference.

### GOVERNMENT SUPPORT

This invention was made with government support under ECCS-2238363 awarded by the National Science Foundation. The government has certain rights in the invention.

### FIELD OF THE DISCLOSURE

The present disclosure relates generally to electromagnetic actuator devices. More specifically, the present disclosure relates to a multimodal actuator implementing a multimodal haptic feedback system with 5 degrees of freedom.

### BACKGROUND OF THE DISCLOSURE

Intuitive and effective human-machine interfaces (HMI) play a pivotal role in artificial intelligence, spanning from robotics and rehabilitation to remote operations, smart manufacturing, entertainment, and virtual and augmented reality (VR/AR). Such interfaces have predominantly depended on visual and auditory feedback, as well as conventional control interfaces, such as mice, keyboards, touchpads, and joysticks. Tactile perception, exploiting humans' subtle and complex sense of touch, remains underutilized due to the lack of efficient skin-compatible transducers to generate dynamic mechanical stimuli on the skin.

The skin, being the largest sensory organ in the human body, serves as a crucial medium for transmitting diverse information to the human sensory system. The tactile sensation is achieved by triggering cutaneous receptors of the skin with various stimuli. For instance, Pacinian corpuscles primarily respond to rapid vibrations, Merkel cells are sensitive to pressure, and Ruffini endings are in response to skin stretch. Conventional haptic devices often employ a single actuation mode, with vibration being the most commonly used stimuli. While vibration has been investigated for delivering haptic information regarding surface roughness through the application of different frequencies, vibratory actuators are ineffective in conveying detailed information about shape and surface structure.

To address the limitations of the conventional actuators and provide users with rich tactile sensations, tactile interactions in rotational shear mode have been explored, where the rotational movement of a tactor is employed to stimulate cutaneous receptors. Pneumatic or hydraulic actuators and servo motors have been widely explored to exert a rotational shear force. Rotation shear force could generate haptic sensations that carry angular information from 3-dimensional (3D) solid surfaces, such as the edge angle and corner angle of an object. Though effective, the presence of heavy supply devices compromise the overall portability and compactness of both pneumatic and hydraulic actuators. Similarly, servo motors share the disadvantage of being bulky and rigid.

Dielectric Elastomer Actuators (DEA) have emerged as a promising alternative. By using soft polymeric materials, DEA-based haptic devices possess excellent flexibility and portability. However, they require high voltages (up to kilovolts) for actuation and can only achieve limited displacement.

In addition to the tactile interactions based on normal pressure/vibration and rotational shear, skin dragging is highly effective in delivering directional cues. Existing research typically employs large-area vibration actuator arrays and sequentially triggers each actuator in different skin locations to create directional patterns. These devices rely on a complex control system and a large placement space while providing one single degree of freedom (DOF) in the normal mode motion. Only a few haptic devices have demonstrated haptic sensations in both skin dragging and normal mode. For instance, a haptic device based on electromagnetic actuation achieved both normal and skin dragging haptic sensations, but the haptic interactions are limited to 2-DOF. Recent research efforts have been devoted to exploring a 5-DOF actuator using shape memory alloys (SMA). However, the SMA-based actuation mechanism faces challenges in terms of response time and efficiency due to the prolonged heating/cooling time.

Moreover, except for DEA-based devices, other haptic interfaces fail to match the stretchability of the skin. Previous user studies have revealed that devices without stretchability have led to poor efficiency in haptic interactions as well as unsatisfied user experiences. Skin-like stretchability and softness are essential to minimize the influence on the user's intuitive actions, improve the mechanical robustness of the device during daily skin deformations, and more importantly, ensure intimate skin contact for precise delivery of mechanical stimuli.

However, there remains a notable gap in the development of stretchable and lightweight haptic interfaces that can trigger multiple mechanical cutaneous receptors through one single device.

### SUMMARY OF THE DISCLOSURE

An aspect of the present disclosure provides a multimodal actuator. The multimodal actuator includes a plurality of electromagnetic coils having a planar spiral aspect, the plurality of electromagnetic coils being arranged in a partially overlapping pattern; a magnet in magnetic communication with the plurality of electromagnetic coils; and a spring structure, having a first surface facing the magnet, and a second surface opposite the first surface.

Another aspect of the present disclosure provides a haptic feedback system. The haptic feedback system includes a multimodal actuator having: a plurality of electromagnetic coils having a planar spiral aspect, the plurality of electromagnetic coils being arranged in an overlapping pattern, a magnet positioned over a center of the plurality of electromagnetic coils and configured to freely move in response to magnetic fields generated by the plurality of electromagnetic coils, and a spring structure, having a bottom surface facing the magnet, and a top surface opposite the bottom surface, the spring structure arranged to limit movement of the magnet in response to the magnetic fields. Additionally, the haptic feedback system includes a power source, and a controller controllably coupling the power source to the plurality of electromagnetic coils. The controller individually controls the electrical output of the power source to each of the plurality of electromagnetic coils in response to input signals received by the controller.

Yet another aspect of the present disclosure provides a wearable article to which at least one multimodal actuator is affixed. The wearable article is configured to hold the at least one multimodal actuator in contact with a region of skin of a wearer.

### BRIEF DESCRIPTION OF THE DRAWINGS

These and other features, aspects, and advantages of the present invention will become better understood with regard to the following description, appended claims, and accompanying drawings.

FIG. 1A illustrates an exploded view of an embodiment of a multimodal actuator in accordance with aspects of the present disclosure.

FIG. 1B illustrates a top-down view of an arrangement of planar spiral coils of the multimodal actuator shown in FIG. 1A, and in accordance with aspects of the present disclosure.

FIG. 2A illustrates a block representation of a magnet in a rest position with respect to contact area of skin in accordance with aspects of the present disclosure.

FIG. 2B illustrates a block representation of a magnet in a normal mode with respect to contact area of skin in accordance with aspects of the present disclosure.

FIG. 2C illustrates a block representation of a magnet in a rotation mode with respect to contact area of skin in accordance with aspects of the present disclosure.

FIG. 2D illustrates a block representation of a magnet in a drag mode with respect to contact area of skin in accordance with aspects of the present disclosure.

FIG. 2E illustrates a representation of the magnet shown in FIG. 2A with corresponding coils in accordance with aspects of the present disclosure.

FIG. 2F illustrates a representation of the magnet shown in FIG. 2B with corresponding coils in accordance with aspects of the present disclosure.

FIG. 2G illustrates a representation of the magnet shown in FIG. 2C with corresponding coils in accordance with aspects of the present disclosure.

FIG. 2H illustrates a representation of the magnet shown in FIG. 2D with corresponding coils in accordance with aspects of the present disclosure.

FIG. 3A illustrates a representation of several kirigami springs in accordance with aspects of the present disclosure.

FIG. 3B illustrates a graphical representation of stress/strain characteristics for the kirigami springs shown in FIG. 3A in accordance with aspects of the present disclosure.

FIG. 4 illustrates a representation of the serial pattern kirigami spring shown in FIG. 3A in accordance with aspects of the present disclosure.

FIG. 5 illustrates a block representation of an embodiment of a haptic feedback system in accordance with aspects of the present disclosure.

FIG. 6 illustrates a block representation of an embodiment of a wearable haptic feedback system in accordance with aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION OF DISCLOSURE

The following detailed description of embodiments of the invention will be made in reference to the accompanying drawings. In describing the invention, explanation about related functions or constructions known in the art are omitted for the sake of clearness in understanding the concept of the invention to avoid obscuring the invention with unnecessary detail.

### INTRODUCTION

Embodiments of the invention disclosed herein provide an multimodal actuator device (also referenced hereinbelow as “electromagnetic actuator” or “actuator”) and haptic feedback systems incorporating the same. Some embodiments of the electromagnetic actuator device may be a multimodal, stretchable haptic interface having five planar spiral electromagnetic coils, a magnetized soft (e.g., pliable, flexible, and/or elastic) elastomeric magnet, and a kirigami-engineered spring structure. In some embodiments, the planar spiral electromagnetic coils may be multi-layer printed metal coils. Passing current through the planar spiral electromagnetic coils, causes a controllable magnetic field that interacts with the soft magnet, thus providing normal (i.e., motion perpendicular to the skin surface), rotational shear, and dragging motions on the skin. Skin-compatible, stretchable elastomers and self-assembled micro-pillars may enhance frictional and normal forces, ensuring rich tactile sensations. The multimodal actuator device may support frequencies up to hundreds of hertz, forces over 20 mN, and angular displacements exceeding 50°, enabling comprehensive cutaneous stimulation. The multimodal actuator device may be incorporated into a system that is lightweight, compact, and suitable for skin-integrated human-machine interactions.

In some embodiments, the electromagnetic actuator device and system may be incorporated into a wearable, flexible article (e.g., adhesive pads, gloves, shirts, prosthetics and the like) that can provide multiple types of touch sensations, such as tapping, angular shearing, and sliding feelings, directly on a user's skin. Some embodiments may be used in such applications as VR/AR environments, smart prosthetics, navigation aids, and wearable training tools, making digital experiences and remote operations more immersive and intuitive.

Thus, embodiments of the present invention may address a growing demand for intuitive, efficient human-machine interfaces in fields such as robotics, prosthetics, VR/AR, remote operations, and smart manufacturing. Existing haptic devices often rely on single-mode stimuli and rigid structures that limit comfort, portability, and realism. By delivering rich, multimodal tactile sensations, (e.g., normal, rotational shear, and dragging) through a single, lightweight, skin-compatible device, some embodiments may provide more comprehensive and naturalistic feedback. The stretchability and skin-like softness of some embodiments may improve user comfort, making it ideal for delivering rich haptic information in diverse applications, such as industrial operation alerts, prosthetic feedback for enhanced environmental perception, navigation guidance for visually impaired users, and immersive entertainment experiences.

In certain embodiments, the electromagnetic actuator device may be used for wearable haptic feedback interfaces for industrial operations. Teleoperation, robotic assembly lines, and maintenance technicians could use these devices for real-time tactile alerts on equipment status, reducing reliance on visual or auditory signals.

In certain embodiments, the electromagnetic actuator device may be used for advanced robotics and teleoperation controls. Engineers, researchers, and operators manipulating robotic arms, machines, or drones from a distance may benefit from precise tactile feedback to sense object hardness, angles, or motion direction, improving the fidelity of remote manipulation.

In certain embodiments, the electromagnetic actuator device may be used for training and simulation platforms. Trainees in fields like surgery, vehicle operation, or machinery handling could receive realistic tactile cues to practice complex tasks, improving skill retention and confidence.

In certain embodiments, the electromagnetic actuator device may be used for telemedicine examination tools. Clinicians and patients engaged in remote healthcare consultations could feel physical cues simulated by the device, aiding in performing virtual examinations or physical rehabilitation exercises.

In certain embodiments, the electromagnetic actuator device may be used for haptic wearables for entertainment and education. Artists, performers, or educators could deliver subtle tactile patterns to convey directional instructions, simulate textures, or highlight certain elements of a learning experience, enriching engagement.

In certain embodiments, the electromagnetic actuator device may be used for haptic prosthetic enhancement. Individuals using prosthetic limbs could benefit from enhanced tactile sensations that restore a sense of touch, improving control and perception during daily activities.

In certain embodiments, the electromagnetic actuator device may be used for VR/AR gaming controllers. Gamers and virtual environment users could experience more natural and immersive tactile feedback—such as simulating surface angles or directional cues—enhancing realism and engagement.

In certain embodiments, the electromagnetic actuator device may be used for navigation aids for accessibility. Haptic sensation can be encoded to deliver visual or hearing cues, serving as sensory substitutes for people with vision or hearing problems. For instance, visually impaired users could utilize the device as a directional guidance tool, receiving haptic signals for turning, stopping, or moving forward, facilitating safer and more independent travel.

In certain embodiments, the electromagnetic actuator device may provide multimodality in a single device. Unlike conventional haptic solutions that rely on single-mode stimuli, this device combines normal, rotational shear, and dragging modes in one platform, providing richer and more versatile tactile sensations.

In certain embodiments, the electromagnetic actuator device may provide skin-like stretchability and softness. Its soft, elastomeric construction and Kirigami-engineered springs enable close conformity to the body. Competing devices are often bulky or rigid, reducing wearability and user acceptance.

In certain embodiments, the electromagnetic actuator device may provide a lightweight and compact form factor. The planar spiral coil design and thin, soft magnet reduce overall thickness and bulk. In contrast, pneumatic, hydraulic, or servo motor-based devices require heavy external supply units or larger components.

In certain embodiments, the electromagnetic actuator device may provide reduced complexity for directional cues. Directional and angular feedback can be achieved without complex actuator arrays or intricate control systems, simplifying integration with various applications and potentially lowering costs.

In certain embodiments, the electromagnetic actuator device may provide enhanced frictional interface with skin. Self-assembled micro-pillars on the contact surface increase normal and shear pressure, improving the sensation of tactile cues without needing to increase current or device size.

In certain embodiments, the electromagnetic actuator device may provide a large frequency range. Capable of stable operation at frequencies up to hundreds of hertz, allowing the electromagnetic actuator device to deliver both slow tapping and fast vibratory cues, outperforming many alternatives with limited frequency response.

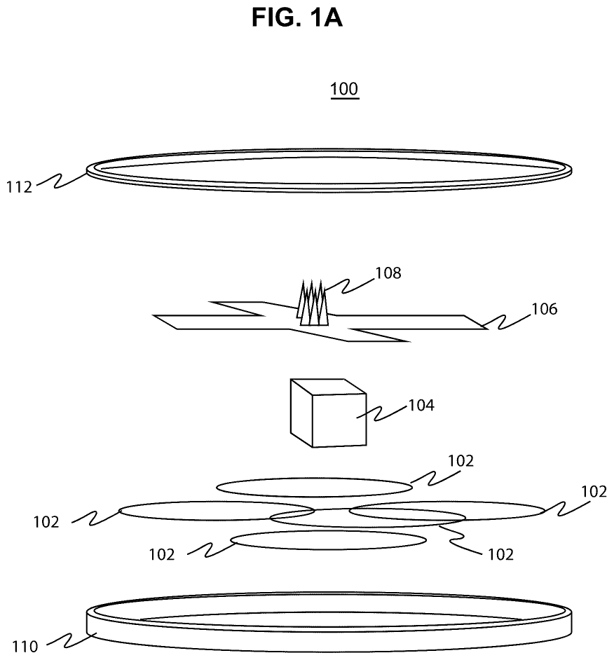

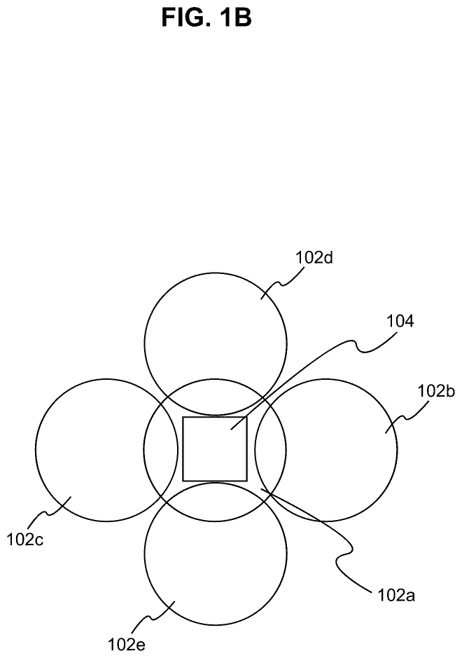

The embodiments disclosed herein rely on a novel electromagnetic actuator 100, shown in exploded view in FIG. 1A. The electromagnetic actuator 100 includes a plurality of planar spiral coils 102 configured as electromagnetic inductors. The embodiment shown in FIG. 1A has five planar spiral coils 102a-102e (shown in FIG. 1B), however any plural number of coils may be used based on the particular application without deviating from the present invention. As shown in FIG. 1B, the plurality of coils 102 are arranged with a first coil 102b is centrally positioned. The remaining coils 102a, 102c, 102d, and 102e are arranged in a pattern surrounding and partially overlapping the first coil 102b.

While FIG. 1B shows an arrangement of five coils 102, it should be understood that any plurality of coils may be used without deviating from the scope of the present invention. For example, an embodiment may include two coils that partially overlap one another. In such an embodiment, the magnet is limited to sliding linearly along a single axis (e.g., left-right) in drag mode, rotation along the same axis in rotational shear mode, as well as upward in normal mode. The various modes may be accomplished by energizing one or both coils. Other embodiments may include more than five coils as well. As additional coils are added, the electromagnetic actuator 100 may allow greater degrees of freedom, finer motion control of the magnet, or both. Therefore, it should be readily apparent to one of ordinary skill that embodiments may include any plural number (e.g., 2, 3, 4, 5, 6, 7, 8, 9, and so on) of coils 102. The number of coils 102 is limited only by the intend application and fabrication constraints.

Additionally, a soft magnet 104 (a composite with magnetic particles dispersed in a polymer matrix) is positioned in alignment with a central point of the plurality of planar spiral coils 102. When current passes through selected coils 102, the generated magnetic field enables a multi-modal actuation of the soft magnet 104. The movement of the soft magnet 104 generates a multi-modal tactile sensation on a contact region of skin.

A spring 106 (e.g., Kirigami spring) is included to provide a resistant force to the soft magnet 104, which prevents the soft magnet 104 from flipping when subjected to magnetic force. The spring 106 helps the magnet restore its position to the center of the device when coils are de-energized. It is noted that while the present disclosure refers to the spring 106 as a Kirigami spring, the present invention is not limited to only Kirigami springs, rather any spring structure may be used that satisfies the dimensional and physical properties necessary to accomplish the above-identified functions.

Regardless of the type of structure used as a spring 106 in embodiments, the spring 106 should not impede the displacement of the soft magnet 104. Simultaneously, the spring 106 must provide a sufficient restoring force to prevent the magnet 104 from flipping, and to ensure that the magnet 104 returns to its central equilibrium (e.g. rest) position once the input power is deactivated.

Alternative materials may be used as well to fabricate the spring 106, including: elastomers, thermoplastics, polymer composites, textile-based matrices, fiber-reinforced networks, and combinations thereof.

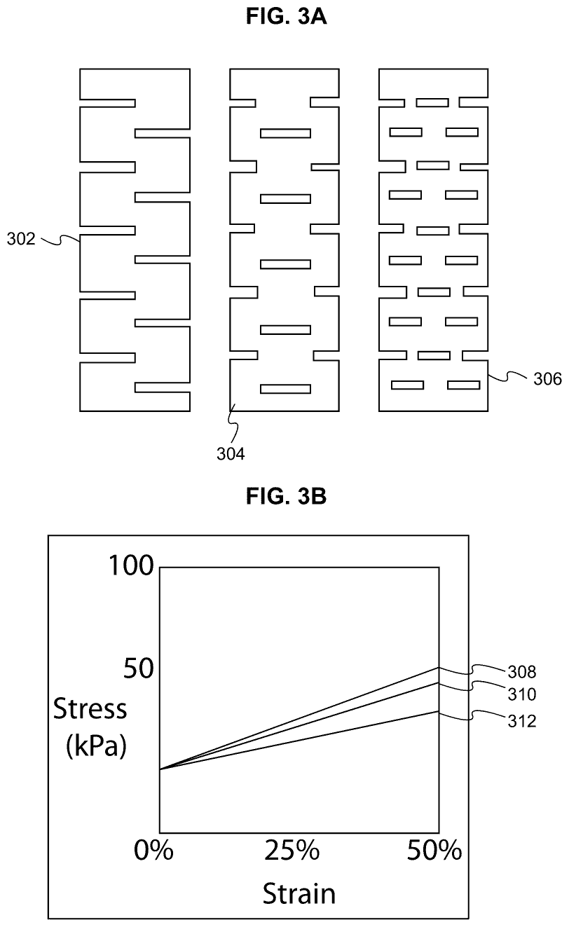

Structurally, the spring may utilize geometries including: Kirigami cut patterns not limited to the ones shown in FIG. 3A, origami-inspired folding structures, spiral geometries (e.g., Archimedean spirals), serpentine or meander beams, auxetic lattice structures, fractal curves, and membrane flexures.

Optionally, self-assembled pillars 108 are introduced to improve the normal pressure and sliding friction applied onto the contact region of skin during actuation.

The above components may be integrated using a soft frame 110 that provides structural support to the haptic device. Moreover, in certain embodiments, an attachment layer 112 constructed of a thin, skin-safe silicone adhesive may be added to the top surface of the soft frame 110 to enable a secure and repetitive attachment on the skin. The attachment layer 112 may not be necessary in embodiments in which the electromagnetic actuator 100 is incorporated into a wearable article, such as a glove, smart watch, wristband, headband or other such articles that are capable of holding the electromagnetic actuator 100 in contact with a wear's skin.

In some embodiments, the soft frame 110 may be formed as an enclosure in which the coils 102, magnet 104 and spring 106 are held. In other embodiments, the soft frame 110 may be formed as a unitary body, such that the coils 102 are directly printed on, or within, a base of the soft frame 110 and the spring 106 holds the magnet 104 in place. In such embodiments, the spring 106 may be dimensioned to form an encapsulating membrane sealing the magnet 104 between the spring 106 and the base of the soft frame 110.

### Properties of Multi-Modal Actuation of the Electromagnetic Actuator

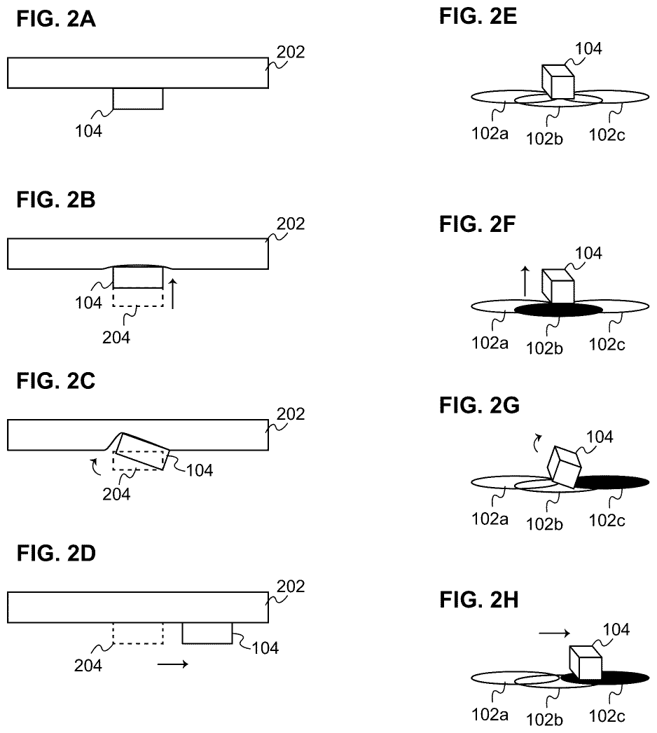

As shown in FIG. 2A-2D, the actuator 100 allows for three modes of motion: normal (shown in FIG. 2B), rotational shear (shown in FIG. 2C), and dragging (shown in FIG. 2D), where FIG. 2A shows the soft magnet 104 in a default rest position. These three modes are capable of stimulating corresponding cutaneous receptors to generate various haptic sensations. For instance, Merkel disks can be stimulated by normal and rotational pressure/force provided in normal and rotational shear modes. Pacinian corpuscles can be stimulated by vibration provided in the normal mode. Ruffini organs can be stimulated by directional skin stretch provided in the dragging mode.

The soft magnet 104 may be actuated with different motions based on the current direction applied to the energized coil and the magnet's 104 relative position to the energized coil (shown in FIG. 2E-2H). Since the distribution of coils 102 is the same along the x-axis and the y-axis, only coils distributed along the y-axis are shown. Additionally, only the working status where the soft magnet 104 is located above the coils 102 is considered.

The following provides a detailed description of the physics behind the operation of the coils 102 and magnet 104 in the context of the present invention.

In the interaction between the energized coil 102 and the soft magnet 104, the current-carrying coil generates a magnetic field, which interacts with the magnetic field of the soft magnet 104, resulting in a force (F_{mag}∈ [symbol] ) experienced by the soft magnet 104:

$${F}_{mag} = {V}_{r} ( M \cdot ∇ ) {B}_{coil} ( x , y , z ) \qquad ( 1 )$$

where F_{mag} is the magnetic force produced by the coil 102, Vᵣ is the volume of the soft magnet 104, M is the magnetization of the soft magnet 104 (M∈ [symbol] ), and B_{coil} (x, y, z) is the magnetic flux density produced by the current-carrying coil 102 (B_{coil}∈ [symbol] ).

According to the Biot-Savart law, the magnetic flux density produced by the single loop coil 102 can be calculated as follows:

$${B}_{coil} = \frac{{μ}_{0}}{4 π} {\int }_{C} \frac{Idl \times {r}^{′}}{{\vert {r}^{′} \vert}^{3}} \qquad ( 2 )$$

where μ₀ is the vacuum permeability, [symbol] represents the loop, I is the current applied to the coil, r′ is the displacement vector (r′∈ [symbol] ) from the current element Idl to any point on the loop (l∈ [symbol] ).

Since the magnetic field generated by the planar spiral coil 102 is symmetrical, the y-z plane is selected for the explanation. Only the clockwise rotation around the x-axis (+Δθₓ) in the rotational shear mode and the linear movement along the positive y-axis (+Δy) in the dragging mode are used as examples to explain the actuation mechanisms. Moreover, in the embodiments disclosed below, the magnet 104 is oriented so that the north pole of the magnet 104 faces the coils 102. As understood in the art, orienting the magnet 104 with the south pole facing the coils 102 would necessitate reversing the magnetic fields induced by the coils 102 to achieve the below-described effects.

As shown in FIG. 2A, the magnet 104 is at an initial rest position, when the coils 102 are not energized, represented in FIG. 2E. When the central coil 102b (in FIG. 2F) is energized, the magnet 104 experiences a repelling magnetic force directed towards the skin surface 202 from the initial position 204 of the magnet 104 (in FIG. 2B). Varying the amount of current flowing through the central coil allows control of the normal force being applied to the skin 202. This mode of operation is referenced as normal mode hereinbelow.

For example, in the normal mode (FIGS. 2B and 2F), the center coil is energized by a counterclockwise current. The force that the soft magnet experienced can be analyzed as:

$${F}_{mag} + {F}_{spr 1} + {F}_{spr 2} + {F}_{skin \_ normal} + {N}_{c - m} + G = m \cdot \ddot{s} \qquad ( 3 )$$

$${F}_{s p r} = k \cdot s \qquad ( 4 )$$

where m is the mass of the soft magnet, s is the displacement of the soft magnet from the initial position (s∈ [symbol] ), \ddot{s} is the second derivative of the displacement s (i.e., acceleration of the soft magnet), F_{skin_normal} is the resistant force induced by the skin, N_{c-m} is the support force induced by the coil, G is the gravitational force (N_{c-m}, G∈ [symbol] , they are hidden in the schematic illustrations for clarity), Fₛₚᵣ₁ and Fₛₚᵣ₂ indicate the resistance from the Kirigami spring (Fₛₚᵣ₁, Fₛₚᵣ₂∈ [symbol] ), k is the spring constant of the Kirigami structure.

Since the magnet 104 is located at the center of the energized coil 102b initially, resistances from the Kirigami springs are equal and balanced in the y-axis. The magnetic field provides the magnet 104 with a repulsive magnetic force along the z-axis. When the current flowing through the coil 102b is large enough, the magnet 104 exhibits a linear motion along the z-axis (+Δz). Based on Newton's Third Law of Motion, in normal mode, the force (Fₙₒᵣₘₐₗ∈ [symbol] ) that the actuator may provide to the skin can be calculated as:

$${F}_{normal} = - {F}_{skin \_ normal} \qquad ( 5 )$$

FIG. 2C shows the magnet 104 producing a rotational sensation (rotational shear mode) on the skin 202. To induce the rotational motion, a peripheral coil (e.g., coil 102c in FIG. 2G) is energized with a current configured to induce a repulsive magnetic field on the magnet 104. The repulsive magnetic field causes the magnet 104 to rotate, thus creating a rotational sensation.

In the rotational shear mode, the right coil 102c is energized by a counterclockwise current. The force that the magnet 104 experiences can be expressed as:

$${F}_{mag} + {F}_{spr 1} + {F}_{spr 2} + {T}_{skin \_ shear} + {N}_{c - m} + G = m \cdot \ddot{s} \qquad ( 6 )$$

where T_{skin_shear} (T_{skin_shear}∈ [symbol] ) indicates the torque induced by the skin.

The magnet 104 is located at the left part of the energized coil 102c initially. Based on Equation 1 and 2, the magnet 104 experiences a repulsive magnetic field force oriented at an angle to the z-axis. When the current flowing through the coil 102c is large enough, F_{mag} will become larger than the total resistance force from all external sources. Then the resultant force provides a torque to rotate the magnet 104. Consequently, the magnet 104 undergoes a net force with an angle to the z-axis that leads to a clockwise rotation around the x-axis (+Δθₓ). In rotational shear mode, the torque (Tₛₕₑₐᵣ∈ [symbol] ) that the actuator could provide to the skin can be expressed as:

$${T}_{shear} = - {T}_{skin \_ shear} \qquad ( 7 )$$

However, if an attractive magnetic field is induced by the peripheral coil 102c (in FIG. 2H), the magnet 104 is pulled towards the center of the peripheral coil 102c, thus inducing a dragging sensation (dragging mode) on the skin 202 as illustrated in FIG. 2D.

In the dragging mode, the right coil 102c is energized by a clockwise current. The force experienced by the magnet 104 can be analyzed as:

$${F}_{mag} + {F}_{coil} + {F}_{spr} + {F}_{skin \_ drag} + {N}_{c - m} + G = m \cdot \ddot{s} \qquad ( 8 )$$

where F_{coil} is the friction induced by the magnet/coil interface (F_{coil}∈ [symbol] ), and its direction opposes the motion of the magnet 104. The magnitude of F_{coil} can be calculated as:

$${F}_{coil} = {μ}_{c - m} \cdot {N}_{c - m} \qquad ( 9 )$$

where μ_{c-m} is the coefficient of friction at the magnet/coil interface. F_{skin_drag} is the friction induced by the human skin/magnet interface (F_{skin_drag}∈ [symbol] ), and its direction opposes the motion of the magnet 104. The magnitude of F_{skin_drag} can be calculated as:

$${F}_{skin \_ drag} = {μ}_{s - m} \cdot {N}_{s - m} \qquad ( 10 )$$

where μₛ₋ₘ is the coefficient of the friction at the human skin/magnet interface, Nₛ₋ₘ is the normal force between the magnet 104 and the skin 202, and its direction is perpendicular to the skin 202.

Since the magnet 104 moves from the coil's 102c left part to the center, only the left spring extends and provides resistance. Based on Equation 1 and 2, the magnet experiences an attractive magnetic field force. When the current flowing through the coil is large enough, F_{mag} along the y-axis is larger than the total force from the coil (F_{coil}), the skin (F_{skin_drag}), and the spring (Fₛₚᵣ). The resultant force attracts the magnet 104 toward the energized coil's 102c central axis. Therefore, the magnet 104 exhibits a linear motion along the y-axis (+Δy). Thus, in the dragging mode, the force (F_{drag}∈ [symbol] ) that the actuator can provide to human skin 202 can be expressed as:

$${F}_{drag} = - {F}_{skin \_ drag} \qquad ( 11 )$$

### Coil Fabrication

In some embodiments the coils 102 may be fabricated using electric field assisted direct ink writing (EADIW). The application of an electric field in the EADIW process reduces the existing material size, improves the printing resolution, and ensures the continuity and consistency of the printed patterns. Field's Metal (i.e., an alloy of iridium, bismuth and tin with a melting point of approximately 62° C.) may be selected as the conductive material for the coil due to its excellent printability, electrical conductivity, and flexibility. Other metal alloys having similar properties and suitability for EADIW fabrication may be used in place of Field's Metal, for example eutectic gallium-indium (EGaIn), galinstan, gallium, Wood's metal, Rose's metal, bismuth-tin (Bi—Sn) alloys, indium-bismuth (In—Bi) alloys, and any metal alloy combination having a melting point below 100° C.

The presence of an electric field increases the printing quality, since the absence of electrostatic attraction between the metal ink and substrate may lead to printing discontinuity and inconsistency in the printed line width. Within a commonly used voltage ranging from 0.5 to 2V (1000 to 4000V after magnification), the printing quality and line width are not sensitive to the variation in voltage. To achieve a large actuation force, the magnetic flux density B_{coil} may be optimized (Equation 2) by adjusting radius (R), number of turns (η), and applied current (I) of the coil 102. A coil 102 with a smaller radius and a larger number of turns will generate a larger magnetic flux density. Considering the range of displacement of the magnet 104 in the dragging mode and the printing capability, the linewidth, line spacing, and number of turns of the coil 102 may be optimized to be around 150 μm, 100 μm, and 12 turns, respectively. The coils 102 may be printed into two layers to enhance the magnetic flux density B_{coil}. Additionally, the coils may require interceding layers of electrically insulating material in order to electrically isolate the coils from one another. These parameters ensure low coil resistance, less electric heat generated during actuation, and reliable printing quality. The resulting resistance may be around 602 and with a current capacity of around 0.8 A.

As predicted in Equation 2, the coil 102, fabricated to the above parameters, generates a higher magnetic flux density with a higher current applied. Although the coils 102 are not directly attached to the skin, the temperature generated by the coil 102 should be below 45° C., to prevent causing pain sensation if the user accidentally makes skin contact with the coil 102. Therefore, 0.6 A may be chosen as an appropriate working current.

The magnetic flux density generated by the coil 102 when the coil 102 is subjected to bending and stretching exhibits only slight variations when the coil 102 is bent (with an angle of around 40° to match the curvature of a fingertip) and stretched (with around 15% tensile strain to match the elastic range of the skin).

### Soft Magnet Fabrication

Based on Maxwell's equations, the correlation between the magnetization M and the magnetic flux density of the soft magnet 104 (B_{mag}∈ [symbol] ) is:

$$M = \frac{χ}{1 + χ} . \frac{{B}_{mag}}{{μ}_{0}} \qquad ( 12 )$$

whereχ indicates the volume magnetic susceptibility and μ₀ is the vacuum permeability.

From Equation 12, increasing the magnetic flux density (B_{mag}) of the soft magnet 104 increases the magnetization and positively influences the magnetic field force (Equation 1), given the predetermined B_{coil}. Since the soft magnet 104 is magnetized along the z-axis, B_{mag} is approximated as B_{mag} (along the z-axis).

Since embodiments of the present invention require a strong remnant magnetic field to interact with the external magnetic field and to form the soft magnet 104, a hard magnetic material, Neodymium Iron Boron (NdFeB) for example, may be used as a magnetic filler for the soft magnet 104. Other hard magnetic filler materials, such as: samarium-cobalt (SmCo), strontium ferrite, barium ferrite, alnico, iron-platinum (FePt), iron nitride, and any combinations of these may be used in place of, or in combination with NdFe may be used as filler material for the soft magnet 104, as well. However, the ratio of filler material to matrix material may need to be adjusted based on the magnetic material used. The below embodiment describes ratios of filler to matrix material that work for NdFeB in particular, and may not be appropriate for other filler materials.

The matrix material should be able to accommodate a high loading of NdFeB while retaining softness, which is desirable for the comfortable interactions of the soft magnet 104 with the skin. Among commonly used materials Silicone adhesive and polydimethylsiloxane (PDMS) exhibit a high loading capacity of NdFEB. However, at a high NdFeB concentration (8:1 in weight ratio), the NdFeB/PDMS composite may be too rigid (with a modulus of around 72 MPa), while the NdFeB/silicone adhesive composite may not form a self-standing structure. To have balanced mechanical properties, a mixture of silicone adhesive and PDMS with a weight ratio of 4:1 (named Polymer) may be used as the matrix material. This mixture is able to accommodate a large amount of NdFeB, ensuring a sufficient magnetic flux density. At the same time, the mixture is soft enough to enable a low modulus of the resulting soft magnet 104.

It is found that the magnetic flux density (B_{mag}) increases with increased concentration of NdFeB. However, when the concentration is beyond 8:1, the soft magnet 104 may become friable. The elastic modulus of a sample with the concentration of 8:1 is around 5 MPa, which would be comfortable for interactions with the skin compared with a rigid tactor. Therefore, a NdFeB and polymer weight ratio of 8:1 may be used to fabricate the soft magnet 104, resulting in a B_{mag} of around 58 mT.

### Kirigami Springs

The spring 106 should possess a minimal spring constant to avoid negative impacts on the movement of the soft magnet 104. At the same time, the spring should provide sufficient resistance to prevent the magnet 104 from flipping and ensure the restoration of the soft magnet 104 when the coil current is turned off. Ecoflex0030 is one material that may be used for the spring due to its low elastic modulus. Other materials have appropriate elastic modulus may be used as well. Kirigami structures may be introduced to further reduce the spring constant. During development, springs with three common Kirigami patterns, as shown in FIG. 3A, namely Island 302, Serial 304, and Parallel 306, were fabricated by laser cutting. The spring with the serial pattern 304 exhibited the lowest spring constant (in FIG. 3B).

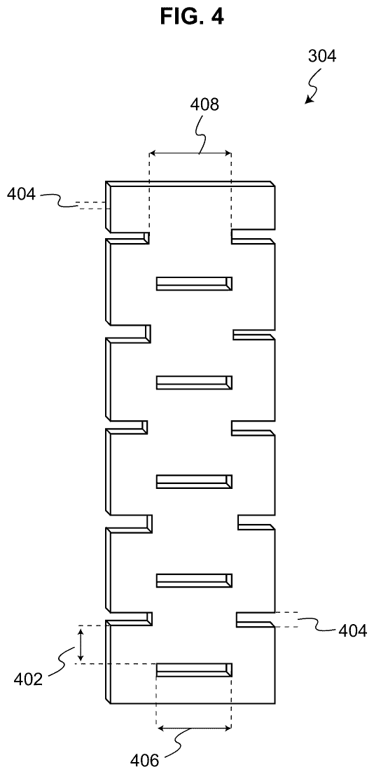

Based on the serial Kirigami pattern 304, the spring constant was further optimized by tailoring its cutting parameters, as presented in FIG. 4. Experimentation shows that springs with smaller thickness 410 possessed a lower spring constant. However, a spring with a thickness 410 of 40 μm may be prone to self-adhesion, owing to its high surface energy. Thus, 80 μm may be an optimal thickness 410 for subsequent parameter optimization. The cut length 406 has a greater influence on the spring constant compared to other spring parameters, this parameter was optimized first. The experimental results demonstrate that the spring constant decreased with increased cut length 406. Keeping the same cut length 406 at 2 mm, a decrease in spring constant was observed when the cut spacing 402 was reduced. However, when the cut spacing 402 was reduced to 0.25 mm, the spring could not provide sufficient resistance. Hence, a cut spacing 402 of 0.5 mm was deemed optimal. A smaller hinge length 408 (0.5 mm) was selected, resulting in a lower spring constant. For the same hinge length 408 of 0.5 mm, the results indicated that a larger cut width 404 further reduced the spring constant. However, the spring with a cut width 404 of 300 μm was unable to provide sufficient resistance for the soft magnet to work at the expected positions. As a result, 20 μm was selected as the desired cut width 404. From the above experimental results, the final optimized configuration for the spring is as follows: serial Kirigami pattern 304, thickness 410 of 80 μm, cutting length 406 of 2 mm, cutting spacing 402 of 0.5 mm, hinge length 408 of 0.5 mm, and cut width 404 of 20 μm.

### Skin Contact Surface

Based on Equation 10, to enhance the dragging force F_{skin_drag} from the soft magnet 104 applied to the skin, the coefficient of friction (μₛ₋ₘ) should be increased. In some embodiments, optional pillar structures 108 are utilized to increase μₛ₋ₘ. A scalable magnetic field-assisted self-assembly process may be used to fabricate pillars. PDMS may be used as a liquid precursor and mixed with varying NdFeB weight ratios. To minimize the added thickness to the device, the pillars 108 should have a low height and provide a large coefficient of friction. The geometry of the pillars 108 and the resulting surface coefficient of friction may be tuned by adjusting the NdFeB weight ratio in the PDMS liquid precursor and the volume of the mixture (NdFeB and PDMS).

Both the NdFeB weight ratio and the volume of the mixture positively influence the pillars' 108 height. To achieve a smaller height of the device, a lower NdFeB:PDMS weight ratio of 1:1 may be selected. By experimentation, the elastic modulus of PDMS:NdFeB with a weight ratio of 1:1 was determined to be around 1 MPa, which may improve haptic sensation without penetrating the human skin. During experimentation, it was determined that when the volume of the mixture increased from 0.03 g to 0.05 g, the surface coefficient of friction increased. Further increasing the mixture volume to 0.07 g may lead to bending of the pillars 108 due to a larger height. Together with a decreased areal pillar density, the surface coefficient of friction is also reduced.

A user study conducted to compare and evaluate the effectiveness of different skin contact surfaces determined that surfaces without pillars 108 and surfaces with pillars made of various volumes of NdFeB and PDMS mixture showed that among all surfaces, the skin contact surface with the pillars 108 made of 0.05 g NdFeB and PDMS mixture provided the most intensive haptic sensation under normal, rotational shear, and dragging mode. Therefore, NdFeB:PDMS ratio of 1:1 and the mixture volume of 0.05 g may be selected to fabricate the optimal pillar structure 108.

### Example Applications

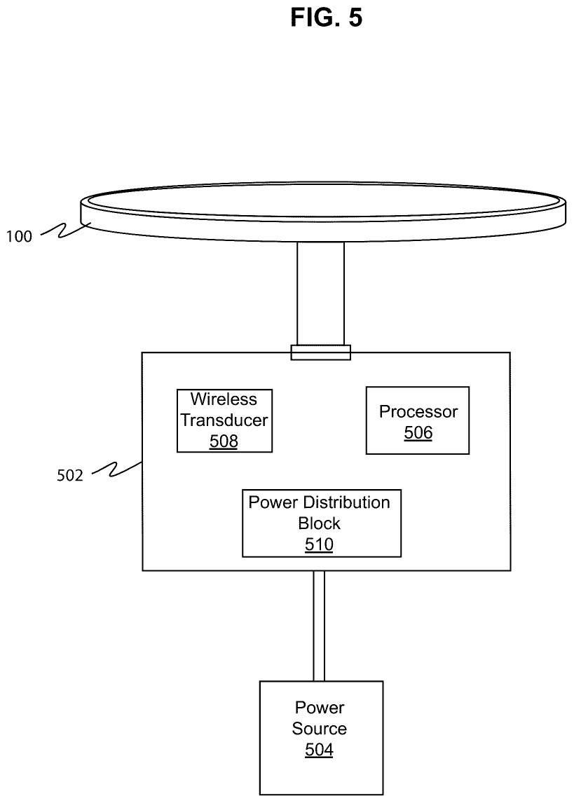

As briefly described above, certain embodiments of the electromagnetic actuator 100 may be utilized in a variety of applications in fields such as robotics, prosthetics, VR/AR, remote operations, and smart manufacturing. As shown in FIG. 5, an embodiment of the electromagnetic actuator 100 may be coupled with a power source 504 and a controller 502. The controller 502 may be configured to controllably couple the power source to a plurality of electromagnetic coils (e.g., 102 in FIG. 1), the controller 502 controls the electrical output of the power source 504 to each of the plurality of electromagnetic coils individually in response to input signals received by the controller 502. The controller 502 may be configured to controllably vary the direction of the current through an individual coil 102, as well as the amplitude and duration of the current. For example, the controller 502 in response to an input signal may cause the power source 504 to energize a coil 102 with a counterclockwise current flow having an amplitude of 600 mA for 100 ms.

The controller 502 may also include a processor 508. The processor 508 may be an ASIC, FPGA, microcontroller, or similar logic circuit implementations. In some embodiments, the controller 502 may include one or more wireless transceivers 506 configured to send and receive signals with an external device. For example, the external device may be a robotic arm, a computer, mobile phone, tablet device, or other device configured to supply input signals for controlling a behavior of the electromagnetic actuator 100. A power distribution block 510 may be included, as well. The power distribution block 510 may be controlled by the processor 508 to direct electrical current to one or more selected electromagnetic actuators 100.

Additionally, the controller 502 may be wired to the electromagnetic actuator 100. In other embodiments the electromagnetic actuator 100 may include wireless transceiver (not shown) implementing a short-range wireless communication protocol (e.g., Bluetooth®, and the like). A Bluetooth® equipped electromagnetic actuator 100 may be coupled wirelessly to a similarly equipped controller 502. In certain embodiments a wireless-enabled electromagnetic actuator 100 may be configured to directly communicate with an external device, thus the external device provides control signals directly to the electromagnetic actuator 100.

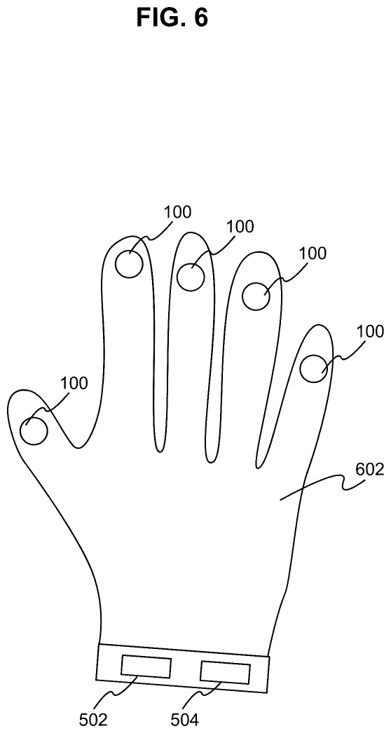

In some embodiments, the electromagnetic actuator 100 may be incorporated into a wearable article, such as a glove 602 (in FIG. 6). For example, a plurality of electromagnetic actuators 100 may be arranged on one or more fingers of the glove 602. The electromagnetic actuators 100 may be wired to a common controller 502 in some embodiment. Alternatively, in other embodiments, each electromagnetic actuators 100 may include a dedicated controller 502. A power source 504 may be integrated into the glove 602. However, in practice integrating the power source 504 into the glove requires that the power source 504 be light, and relatively small, while having an appropriate energy capacity. In alternative embodiments, the power source 504 may be a separate unit coupled to the glove by an electrical cable.

### Performance of the Haptic Device

The performance of an embodiment of the haptic device was evaluated in normal, rotational shear, and dragging modes. Prior research has shown that 100 μm of displacement and 15 mN of force were considered as the threshold to trigger tactile perception in the normal mode. Around 0.3 mm of displacement was considered as the threshold for lateral tactile perception. Displacement and force (normal and dragging modes) or angle and torque (rotational shear mode) were employed as evaluation metrics. The force or torque exhibited a positive correlation with the applied current and the resulting magnetic flux density. Under the normal mode, the actuator could generate a maximum force of approximately 28 mN. Under the rotational shear mode, the device could provide a maximum torque of around 90 mN·mm. When operated in the dragging mode with the magnet held at the center initially, the device achieved a maximum dragging force of 5 mN. Based on the results of the user study (discussed in the next section), the device could sufficiently trigger the skin's tactile sensations under all three modes.

Similarly, an increase in current led to a larger displacement (in normal and dragging modes) or angle (in the rotational shear mode). When the applied current exceeded 0.2 A, the normal displacement exhibited a significant upward trend, reaching a maximum value of around 1.8 mm. In the rotational shear mode, the angular motion induced by electromagnetic forces started to increase beyond a current of 0.25 A and reached 51° at 0.6 A. The dragging displacement followed a similar trend to that of the normal mode. Beyond a current of 0.2 A, the dragging displacement is larger than the required value for triggering tactile sensation (0.3 mm).

The device's performance at dynamic response was then evaluated by applying a current of 0.6 A to the coil at various frequencies. The actuator demonstrated a stable operation at frequencies below 20 Hz in both normal and rotational shear modes. Despite a decrease in displacement as the frequency exceeded 20 Hz, haptic sensation could still be triggered at frequencies up to around 200 Hz. In the dragging mode, the actuator exhibited a favorable performance for frequencies ranging from 1 to 10 Hz. Similarly, although the actuator's performance decreased significantly with further increased frequency, it still surpassed the haptic sensation threshold for frequencies within 80 Hz.

To validate the device's repeatability and cyclic stability in different modes, cyclic testing of 10000 cycles was performed in the normal, rotational shear, and dragging modes. The device demonstrated excellent stability for all three modes. The response time was around 30 ms under normal and rotational shear mode and 100 ms under dragging mode.

### Application of the Normal Mode in Recognition of Different Working Status

In remote industrial operations, haptic devices serve as the interface to provide real-time information regarding a robot's working status to the operators. By this means, the operators can make necessary adjustments during operations. In this scenario, the normal mode of certain embodiments of the haptic device was employed to provide users with indications of the different working statuses of the robot. In an example application, when the robotic arm starts operating by making contact with an object, the actuator may deliver a single tapping to the user. When the object is held by the robotic arms during a normal working status, the actuator may provide a series of low-frequency tapping to inform the user. In case of an emergency, such as slippage of the object, the actuator may provide high-frequency vibrations to alert the user.

To assess the effectiveness of an embodiment of the haptic device in transforming working status information, a user study was conducted. The actuator was worn on the user's fingertips in a blindfolded and acoustically shielded setup. In the experiments, the actuator was activated by a current of 0.6 A for 1 second with a 2-second pause (single tapping), at a frequency of 1 Hz (low-frequency tapping), and at a frequency of 100 Hz (high-frequency vibrations). After each activation, the user was asked to identify the received types of tapping/vibration that represent different working statuses. Each working mode was delivered to the user 70 times randomly, resulting in a total of 210 tests. The user study showed that all three working statuses achieved a perception rate of 100%, indicating an excellent transmission of the working status to the users.

### Application of the Rotational Shear Mode in Recognition of Angular Information

Recognition of 3D solid surfaces is crucial for our interactions with the surrounding world and for delivering information related to different surfaces. As an example, in scenarios where a patient wears a prosthesis, such haptic feedback can improve the patient's control of the prosthesis during physical interactions with the environment, thereby increasing productivity, safety, and comfort. Rotation shear force could generate haptic sensations that carry angular information from 3D solid surfaces, such as the edge angle and corner angle of an object.

In a user study, the angular information corresponding to different surface structures was provided by varying the angle between the skin and the contact surface of an embodiment of the actuator and delivered by triggering cutaneous receptors of the skin. The actuator working in the rotational shear mode was employed to provide the required angular motion. The actuator provided tactile sensations in four different angular movements to mimic the condition in which fingers are in contact with 3D surfaces with different angles. The experimental setup was similar to that of the working status recognition. The actuator was attached to the fingertip and applied with a current of 0.6 A at the frequency of 1 Hz for 3 seconds. Four different angular movements were generated by regulating the coil current. Each angular movement was delivered to the users 70 times randomly. Testing has shown that certain embodiments of the actuator are capable of providing tactile sensations for angular information discrimination, with an average perception rate of 95%.

### Application of the Dragging Mode in the Recognition of Different Navigation Signals

Navigation signal recognition, which involves identifying the different notifications and directions of tactile feedback on the skin, is a desired capability in haptic devices. For instance, providing navigation information through tactile feedback is particularly beneficial for individuals with visual impairments or when the visual sensation is occupied by other tasks (e.g., during driving). In contrast to conventionally employed vibration actuator arrays, our device achieves directional cues in four directions using one single device through a simple control system and requires a smaller placement space for the actuator. A multimodal and multi-DOF haptic device could enrich the users' tactile experience and reduce the fatigue and desensitization caused by receiving a single tactile signal, thus improving the effectiveness of navigation information transmission. To examine the actuator's ability to convey navigation information, the actuator was attached to the wrist for hands-free operation. Seven different navigation signal patterns (i.e., notification, stop, wait, left/right, and forward/backward) were generated by the actuator working in three different working modes. The navigation signal patterns were generated 40 times in a randomized order, resulting in a total of 280 tests. Users were asked to differentiate the navigation signal patterns and the results were summarized in. The user study illustrates an average perception rate of around 95.4% for different navigation signals.

A user study demonstrated that stimuli provided in three different working modes at a low frequency (1 Hz) can be distinguished with an average perception rate of 96.7%. However, it was difficult for the users to distinguish among three different working modes provided at a high frequency (100 Hz).

### Conclusions

A 3-modal 5-DOF wearable electromagnetic actuator for comprehensive haptic information transmission, as disclosed herein may satisfy the requirements of tactile perception as well as matching the elastic properties of the skin. A novel printing method, described above, may be employed to fabricate high-resolution coils with good flexibility and stretchability. With three actuation modes (normal, rotational shear, and dragging), embodiments of the present invention may stimulate multiple cutaneous receptors by providing a force of 28 mN and a displacement of 1.8 mm in the normal mode, a torque of 90 mN·mm and an angle of 51° in the rotational shear mode, and a force of 5 mN and a displacement of 3 mm in the dragging mode.

A Kirigami spring may be introduced to ensure the actuator's functionality and reliability. With integrated self-assembled pillars, the normal/rotational shear pressure and sliding friction delivered by the actuator could be amplified without increasing the applied current. The user studies demonstrate that the haptic device was able to deliver multi-modal haptic sensation and convey information regarding working status (through vibrations), angular surface structure, and directional signals. These demonstrations highlight the potential applications of the haptic device in human-machine interactions across varying fields, including industrial operation, telemedicine, entertainment, and navigation.

While the invention has been shown and described with reference to certain embodiments of the present invention thereof, it will be understood by those skilled in the art that various changes in form and details may be made therein without departing from the spirit and scope of the present invention and equivalents thereof.

### Example Clauses

Implementation examples are described in the following numbered clauses:

Clause 1: An electromagnetic actuator haptic feedback device, comprising: a plurality of electromagnetic coils having a planar spiral aspect, the plurality of electromagnetic coils being arranged in a partially overlapping pattern; a magnet in magnetic communication with the plurality of electromagnetic coils; and a spring structure, having a first surface facing the magnet, and a second surface opposite the first surface.

Clause 2: The electromagnetic actuator haptic feedback device as in Clause 1, further comprising micro-pillars arranged on the second surface of the spring structure, the micro-pillars being configured to communicate movement of the magnet to a contact region of skin.

Clause 3: The electromagnetic actuator haptic feedback device as in any one of Clauses 1 and 2, further comprising a frame surrounding the plurality of electromagnetic coils, the magnet, and the spring structure on at least four sides.

Clause 4: The electromagnetic actuator haptic feedback device as in Clause 3, further comprising an attachment layer disposed on a surface of the frame and configured to hold the electromagnetic actuator in contact with a region of skin.

Clause 5: The electromagnetic actuator haptic feedback device as in any one of Clauses 1-4, wherein the magnet is an elastomer magnet comprising a hard magnetic material and an elastic polymer.

Clause 6: The electromagnetic actuator haptic feedback device as in Clause 5, wherein the hard magnetic material is a magnetic alloy of neodymium, iron and boron (NdFeB).

Clause 7: The electromagnetic actuator haptic feedback device as in any one of Clauses 1-6, wherein the spring structure is a kirigami spring.

Clause 8: A haptic feedback system, comprising: an electromagnetic actuator comprising: a plurality of electromagnetic coils having a planar spiral aspect, the plurality of electromagnetic coils being arranged in an overlapping pattern, a magnet positioned over a center of the plurality of electromagnetic coils and configured to freely move in response to magnetic fields generated by the plurality of electromagnetic coils, and a spring structure, having a bottom surface facing the magnet, and a top surface opposite the bottom surface, the spring structure arranged to limit movement of the magnet in response to the magnetic fields; a power source; and a controller controllably coupling the power source to the first electromagnetic coil, second electromagnetic coil and third electromagnetic coil, the controller individually controlling the electrical output of the power source to each of the plurality of electromagnetic coils in response to input signals received by the controller.

Clause 9: The system as in Clause 8, further comprising a frame surrounding the electromagnetic actuator on at least four sides.

Clause 10: The system as in Clause 9, further comprising an attachment layer disposed on a surface of the frame and configured to hold the electromagnetic actuator in contact with a region of skin.

Clause 11: The system as in any one of Clauses 8-10, wherein the magnet is an elastomer magnet comprising a magnetic alloy of neodymium, iron and boron (NdFeB), and an elastic polymer.

Clause 12: The system as in any one of Clauses 8-11, wherein the spring structure is a kirigami spring.

Clause 13: A wearable haptic feedback system, comprising: at least one electromagnetic actuator comprising: a plurality of electromagnetic coils having a planar spiral aspect, the plurality of electromagnetic coils being arranged in an overlapping pattern, a magnet positioned over a center of the plurality of electromagnetic coils and configured to freely move in response to magnetic fields generated by the plurality of electromagnetic coils, and a spring structure arranged to limit movement of the magnet in response to the magnetic fields; and a wearable article to which the at least one electromagnetic actuator is affixed, the wearable article configured to hold the at least one electromagnetic actuator in contact with a region of skin of a wearer.

Clause 14: The system as in Clause 13, further comprising a power source configured to supply an electrical current to each of the plurality of electromagnetic coils.

Clause 15: The system as in Clause 14, further comprising a controller controllably coupling the power source to the at least one electromagnetic actuator, the controller individually controlling the electrical output of the power source to each of the plurality of electromagnetic coils in response to input signals received by the controller.

Clause 16: The system as in any one of Clauses 13-15, further comprising a frame surrounding the at least one electromagnetic actuator on at least four sides.

Clause 17: The system as in any one of Clauses 13-16, further comprising micro-pillars arranged on a surface of the spring structure opposite the magnet, the micro-pillars being configured to translate motion of the at least one electromagnetic actuator to the region of skin.

Clause 18: The system as in any one of Clauses 13-17, wherein the magnet is an elastomer magnet comprising a hard magnetic material, and an elastic polymer.

Clause 19: The system as in Clause 18, wherein the hard magnetic material is a magnetic alloy of neodymium, iron and boron (NdFeB).

Clause 20: The system as in any one of Clauses 13-19, wherein the spring structure is a kirigami spring.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A multimodal actuator, comprising:
a plurality of electromagnetic coils having a planar spiral aspect, the plurality of electromagnetic coils being arranged in a partially overlapping pattern;
a magnet in magnetic communication with the plurality of electromagnetic coils; and
a spring structure, having a first surface facing the magnet, and a second surface opposite the first surface.

2. The multimodal actuator as in claim 1, further comprising micro-pillars arranged on the second surface of the spring structure, the micro-pillars being configured to communicate movement of the magnet to a contact region of skin.

3. The multimodal actuator as in claim 1, further comprising a frame surrounding the plurality of electromagnetic coils, the magnet, and the spring structure on at least four sides.

4. The multimodal actuator as in claim 3, further comprising an attachment layer disposed on a surface of the frame and configured to hold the electromagnetic actuator haptic feedback device in contact with a region of skin.

5. The multimodal actuator as in claim 1, wherein the magnet is an elastomer magnet comprising a hard magnetic material and an elastic polymer.

6. The multimodal actuator as in claim 5, wherein the hard magnetic material is a magnetic alloy of neodymium, iron and boron (NdFeB).

7. The multimodal actuator as in claim 1, wherein the spring structure is a kirigami spring.

8. A haptic feedback system, comprising:
an multimodal actuator comprising:
a plurality of electromagnetic coils having a planar spiral aspect, the plurality of electromagnetic coils being arranged in an overlapping pattern,
a magnet positioned over a center of the plurality of electromagnetic coils and configured to freely move in response to magnetic fields generated by the plurality of electromagnetic coils, and
a spring structure, having a bottom surface facing the magnet, and a top surface opposite the bottom surface, the spring structure arranged to limit movement of the magnet in response to the magnetic fields;
a power source; and
a controller controllably coupling the power source to the plurality of electromagnetic coils, the controller individually controlling an electrical output of the power source to each of the plurality of electromagnetic coils in response to input signals received by the controller.

9. The haptic feedback system as in claim 8, further comprising a frame surrounding the electromagnetic actuator on at least four sides.

10. The haptic feedback system as in claim 9, further comprising an attachment layer disposed on a surface of the frame and configured to hold the multimodal actuator in contact with a region of skin.

11. The haptic feedback system as in claim 8, wherein the magnet is an elastomer magnet comprising a magnetic alloy of neodymium, iron and boron (NdFeB), and an elastic polymer.

12. The haptic feedback system as in claim 8, wherein the spring structure is a kirigami spring.

13. A wearable haptic feedback system, comprising:
at least one multimodal actuator comprising:
a plurality of electromagnetic coils having a planar spiral aspect, the plurality of electromagnetic coils being arranged in an overlapping pattern,
a magnet positioned over a center of the plurality of electromagnetic coils and configured to freely move in response to magnetic fields generated by the plurality of electromagnetic coils, and
a spring structure arranged to limit movement of the magnet in response to the magnetic fields; and
a wearable article to which the at least one multimodal actuator is affixed, the wearable article configured to hold the at least one multimodal actuator in contact with a region of skin of a wearer.

14. The wearable haptic feedback system as in claim 13, further comprising a power source configured to supply an electrical current to each of the plurality of electromagnetic coils.

15. The wearable haptic feedback system as in claim 14, further comprising a controller controllably coupling the power source to the at least one multimodal actuator, the controller individually controlling an electrical output of the power source to each of the plurality of electromagnetic coils in response to input signals received by the controller.

16. The wearable haptic feedback system as in claim 13, further comprising a frame surrounding the at least one multimodal actuator on at least four sides.

17. The wearable haptic feedback system as in claim 13, further comprising micro-pillars arranged on a surface of the spring structure opposite the magnet, the micro-pillars being configured to translate motion of the at least one multimodal actuator to the region of skin.

18. The wearable haptic feedback system as in claim 13, wherein the magnet is an elastomer magnet comprising a hard magnetic material, and an elastic polymer.

19. The wearable haptic feedback system as in claim 18, wherein the hard magnetic material is a magnetic alloy of neodymium, iron and boron (NdFeB).

20. The wearable haptic feedback system as in claim 13, wherein the spring structure is a kirigami spring.
